(19) United States
(12) Patent Application Publication
(10) Pub. No.: US 2012/0169769 A1
(43) Pub. Date: Jul. 5, 2012

(54) INFORMATION PROCESSING APPARATUS, INFORMATION DISPLAY METHOD, AND COMPUTER PROGRAM

(75) Inventors: Takanori Minamino, Kanagawa (JP); Ko Kobayashi, Tokyo (JP)

(73) Assignee: Sony Corporation, Tokyo (JP)

(21) Appl. No.: 13/299,487

(22) Filed: Nov. 18, 2011

(30) Foreign Application Priority Data
Jan. 5, 2011 (JP) 2011-000346

(51) Int. Cl. G09G 5/00

(52) U.S. Cl. 345/629

(57) ABSTRACT

An information processing apparatus includes: a display section displaying an image; and a control section displaying on the display section a map-view screen including a display of a map cluster including thumbnail images of one or a plurality of images recorded in a recording section with position information attached on a map, and when one map cluster is selected from the map clusters, an index-display confirmation screen including a display of information not displayed on the map-view screen of the map cluster and not displaying the map having been displayed on the map-view screen, and prompting to select whether to display an index of images included in the map cluster.

### BACKGROUND

The present disclosure relates to an information processing apparatus, an information processing method, and a computer program.

Some of electronic devices capable of capturing still images and moving images include a device allowing a user to obtain a current location, such as a GPS (Global Positioning System), and to record an image captured by the user together with position information of the shooting location (for example, refer to Japanese Unexamined Patent Application Publication No. 2010-256940). When an image captured by such an electronic device is displayed or played back by that electronic device, it is necessary for the device to have some features enabling the user to easily grasp the shooting location of the image.

### SUMMARY

However, in order to allow a user to easily grasp a shooting location of an image, it is not sufficient only by mapping a thumbnail image of a captured image on a map. This is because the user is not allowed to obtain information accompanying the captured image. Thus, there has been a problem in that it has been difficult for the user to obtain information on when and how the image was captured at that shooting location, for example.

Accordingly, the present disclosure has been made in view of the above-described problem. It is desirable to provide a new and improved information processing apparatus, information processing method, and computer program that enables a user to obtain information accompanying a captured image by the user selecting a thumbnail image from thumbnail images of captured images that have been mapped on a map.

According to an embodiment of the present disclosure, there is provided an information processing apparatus including: a display section displaying an image; and a control section displaying, on the display section, a map-view screen including a display of a map cluster including thumbnail images of one or a plurality of images recorded in a recording section, with position information attached, on a map, and when one map cluster is selected from the map clusters, an index-display confirmation screen including a display of information not displayed on the map-view screen of the map cluster and not displaying the map having been displayed on the map-view screen, and prompting to select whether to display an index of images included in the map cluster.

When the index-display confirmation screen is displayed on the display section, if a user selects a display of an index of captured images on the display section, the control section may change the display on the display section from the index-display confirmation screen to an index screen displaying the index of the captured images pertaining to the map cluster selected by the user.

In order for the control section to change to the map-view screen after having changed the display on the display section from the index-display confirmation screen to the index screen, the control section may directly change the screen without going through the index-display confirmation screen.

When the control section displays the index-display confirmation screen on the display section, the control section may display information on a shooting date of a captured image pertaining to the map cluster selected as information not having been displayed on the map-view screen.

When the control section displays the index-display confirmation screen on the display section, the control section may display information on latitude and longitude of a shooting location of a captured image pertaining to the map cluster selected as information not having been displayed on the map-view screen.

When the control section displays the index-display confirmation screen on the display section, the control section may display a name of a shooting location of a captured image pertaining to the map cluster selected as information not having been displayed on the map-view screen.

When the control section displays the index-display confirmation screen on the display section, the control section may display a face image included in a captured image pertaining to the map cluster selected as information not having been displayed on the map-view screen.

According to another embodiment of the present disclosure, there is provided a method of displaying information, including: controlling a display of a map-view screen including a display of a map cluster including thumbnail images of one or a plurality of images recorded in a recording section with position information attached on a map on a display section; and when one map cluster is selected from the map clusters, controlling a display of an index-display confirmation screen including a display of information not displayed on the map-view screen of the map cluster and not displaying the map having been displayed on the map-view screen, and prompting to select whether to display an index of images included in the map cluster.

According to another embodiment of the present disclosure, there is provided a computer program for causing a computer to perform processing including: controlling a display of a map-view screen including a display of a map cluster including thumbnail images of one or a plurality of images recorded in a recording section with position information attached on a map on a display section; and when one map cluster is selected from the map clusters, controlling a display of an index-display confirmation screen including a display of information not displayed on the map-view screen of the map cluster and not displaying the map having been displayed on the map-view screen, and prompting to select whether to display an index of images included in the map cluster.

As described above, by the present disclosure, it is possible to provide a new and improved information processing apparatus, information processing method, and computer program that enables a user to obtain information accompanying a captured image by the user selecting a thumbnail image from thumbnail images of captured images that have been mapped on a map.

### BRIEF DESCRIPTION OF THE DRAWINGS

FIG. 1 is an explanatory diagram illustrating an example of an internal configuration of an imaging apparatus according to an embodiment of the present disclosure;

FIG. 2 is an explanatory diagram illustrating an example of a functional configuration of an imaging apparatus according to an embodiment of the present disclosure;

FIG. 3 is a diagram schematically illustrating storage contents of a content-management-information storage section according to an embodiment of the present disclosure;

FIG. 4 is a flowchart illustrating operation of an imaging apparatus according to an embodiment of the present disclosure;

FIG. 5 is an explanatory diagram illustrating an example of transition of screens displayed on a display section of the imaging apparatus;

FIG. 6 is an explanatory diagram illustrating an example of a map-view screen displayed on the display section of an imaging apparatus according to an embodiment of the present disclosure;

FIG. 7 is an explanatory diagram illustrating an example of a map-view screen displayed on the display section of an imaging apparatus according to an embodiment of the present disclosure;

FIG. 8 is an explanatory diagram illustrating a display example of an index-display confirmation screen displayed on the display section of an imaging apparatus according to an embodiment of the present disclosure;

FIG. 9 is an explanatory diagram illustrating a display example of an index screen displayed on the display section of an imaging apparatus according to an embodiment of the present disclosure; and

FIG. 10 is an explanatory diagram illustrating a display example of a playback screen displayed on the display section of an imaging apparatus according to an embodiment of the present disclosure.

### DETAILED DESCRIPTION OF EMBODIMENT

In the following, a detailed description will be given of a preferred embodiment of the present disclosure with reference to the accompanying drawings.

In this regard, in this specification and the drawings, a same reference numeral is given to a component having a substantially same functional configuration, and thereby a redundant explanation is omitted.

In this regard, the description will be given in the following order.

1. An Embodiment of the Present Disclosure

1. 1 Example of Configuration of Imaging Apparatus

1. 2 Operation of Imaging Apparatus

2. Overview

1. An Embodiment of the Present Disclosure

1. 1 Example of Configuration of Imaging Apparatus

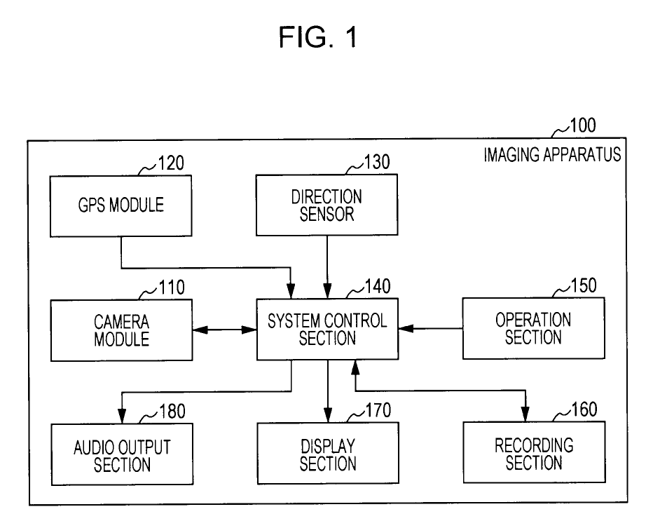

First, a description will be given of an example of an internal configuration of an imaging apparatus 100 according to an embodiment of the present disclosure with reference to the drawings. FIG. 1 is an explanatory diagram illustrating an example of an internal configuration of the imaging apparatus 100 according to an embodiment of the present disclosure. In the following, a description will be given of the internal configuration of the imaging apparatus 100 according to an embodiment of the present disclosure using FIG. 1.

The imaging apparatus 100 illustrated in FIG. 1 is an example of an information processing apparatus of the present disclosure. The imaging apparatus 100 includes a camera module 110, a GPS (Global Positioning System) module 120, a direction sensor 130, and a system control section 140. Also, the imaging apparatus 100 includes an operation section 150, a recording section 160, a display section 170, and an audio output section 180. The imaging apparatus 100 is achieved, for example, by an imaging apparatus, such as a digital still camera, a digital video camera (for example, a camcorder), etc., which captures an image of a subject, generates image data, and records the image data as a content.

The camera module 110 captures an image of a subject to generate a captured image (image data), and outputs the generated captured image to the system control section 140. Specifically, the camera module 110 includes an optical unit, an imaging device and a signal processing section. In the camera module 110, an optical image of the subject entered through the optical unit is formed on a surface of the imaging device. In this state, the imaging device performs image capture operation, and the signal processing section performs signal processing on the imaging signal so as to generate a captured image. And the generated captured image is output to the system control section 140 in sequence.

The GPS module 120 calculates shooting position information on the basis of a GPS signal received by a GPS-signal receiving antenna (not shown in the figure), and outputs the calculated shooting position information to the system control section 140. The calculated shooting position information includes each data on a] location, such as a latitude, a longitude, a height, etc. In this regard, in the embodiment of the present disclosure, an example is given of the case of using the calculated shooting position information on the basis of the GPS signal. However, shooting position information obtained by another method of obtaining shooting position information may be used. For example, shooting position information may be derived using access-point information by a wireless LAN (Local Area Network) existing in a surrounding area, and this shooting position information may be obtained and used.

The direction sensor 130 is a sensor measuring a direction on earth using geomagnetism, and outputs the measured direction to the system control section 140. For example, the direction sensor 130 is a magnetic-field sensor including two-axis mutually orthogonal (for example, x-axis and y-axis) coils, and an MR device (magneto-resistive device) disposed at a central part of the coils. The MR device is a device that detects geomagnetism, and whose resistance changes by the magnetic strength. A change in resistance of the MR device is divided into two-direction components (for example, x-axis and y-axis components) by the two-axis coils, and a direction is calculated on the basis of a ratio of the two-direction components in the geomagnetism.

Here, in an embodiment of the present disclosure, the direction sensor 130 may measure a direction of an imaging direction of the imaging apparatus 100. The imaging direction is a direction from an imaging position (for example, a position at which the imaging apparatus 100 exists) to a position at which a subject included in the captured image generated by the camera module 110, and for example, can be an optical-axis direction of the subject. Also, for example, for the imaging direction, a direction of a subject located at a central position in a captured image can be the imaging direction on the basis of an imaging position. In this regard, in an embodiment of the present disclosure, an example of obtaining an imaging direction using the direction sensor 130 is shown. However, the imaging direction obtained by another method of obtaining an imaging direction may be used. For example, a direction measured on the basis of a GPS signal may be used.

The system control section 140 performs overall control on the imaging apparatus 100. For example, the system control section 140 performs control in accordance with an input operation from a user, which has been accepted by the operation section 150. Also, the system control section 140 controls display of a content selection screen, etc., on the display section 170, and recording and reading, etc., of the captured image on and from the recording section 160. Further, the system control section 140 controls display of a captured image generated by the camera module 110 and a map on its imaging position onto the display section 170 at monitoring-mode setting time or during recording of a moving-image. Here, the monitoring mode is an imaging mode in which a captured image supplied from the camera module 110 is displayed on the display section 170 in real time if the imaging apparatus 100 is in a waiting state of recording an image, for example.

In this embodiment, the system control section 140 performs control to display a map-view screen described below on the display section 170 on the basis of a predetermined input operation from the user. The map-view screen is a screen by which a map is displayed on the display section 170, and is a screen on which a thumbnail image of a content (still image and moving image) captured by the imaging apparatus 100 is displayed in association with a position on the map. Here, when thumbnail images are displayed on the display section 170 in association with positions on the map, the system control section 140 displays thumbnail images of a plurality of images captured in the close vicinity in a bunch. In the following, a bunch of thumbnail images of images is also called a “map cluster”.

When the user performs an input operation of selecting one map cluster in a state in which a map-view screen is displayed on the display section 170, the system control section 140 executes processing for displaying, on the display section 170, an index-display confirmation screen displaying additional information of the image corresponding to the map cluster, and prompting the user to select whether an index screen of the image corresponding to that map cluster.

And in a state in which the index-display confirmation screen is displayed on the display section 170, when the user performs an input operation selecting display of the index screen of the images, the system control section 140 performs processing for displaying the index screen of the image corresponding to the map cluster on the display section 170.

The operation section 150 is an input operation section receiving an input operation from the user, and outputs a signal in accordance with the accepted input operation to the system control section 140.

The recording section 160 records a captured image generated by the camera module 110 as a still-image content or a moving-image content under the control of the system control section 140. Also, the recording section 160 supplies the recorded still-image content or moving-image content to the system control section 140 under the control of the system control section 140. Further, the recording section 160 stores map data for displaying a map on the display section 170. Also, the recording section 160 stores content management information for managing still image contents or moving image contents. In this regard, for the recording section 160, a recording medium, such as a flash memory, etc., can be used, for example. Also, the recording section 160 may be built in the imaging apparatus 100, and may be detachably attached to the imaging apparatus 100.

The display section 170 is a display section displaying various images under the control of the system control section 140. For example, the display section 170 displays a captured image generated by the camera module 110, a still image content or a moving image content read from the recording section 160, and a content selection screen to be provided to the user, etc. For the display section 170, for example, an LCD (Liquid Crystal Display), or an organic EL (Electro Luminescence) can be used. In this regard, the display section 170 may be provided with a touch panel, and the touch panel may have a function of the operation section 150. When the display section 170 is provided with a touch panel, the user of the imaging apparatus 100 is allowed to perform various operations by directly touching the display section 170 with a finger.

The audio output section 180 outputs various kinds of audio information under the control of the system control section 140. The audio output section 180 can be achieved by, for example, a speaker. Here, the various kinds of audio information may be, for example, a sound recorded together with a moving image when a moving image content recorded in the recording section 160 is played back, or may be a sound that is output in accordance with operation of the user when the user of the imaging apparatus 100 performs operation using the operation section 150 of the imaging apparatus 100.

In the above, a description has been given of an internal configuration of the imaging apparatus 100 according to an embodiment of the present disclosure. Next, a description will be given of a functional configuration of the imaging apparatus 100 according to the embodiment of the present disclosure.

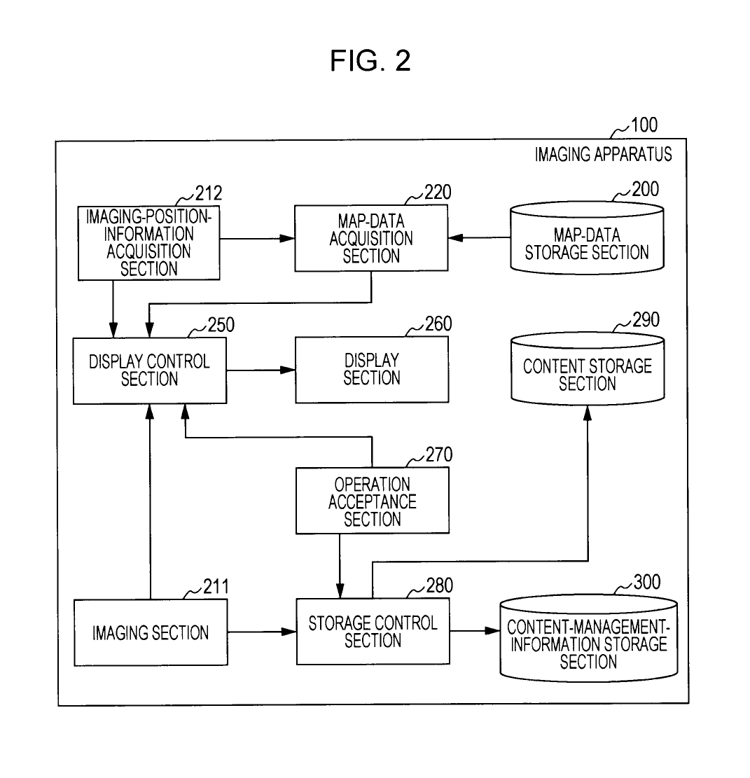

FIG. 2 is an explanatory diagram illustrating an example of a functional configuration of an imaging apparatus 100 according to an embodiment of the present disclosure. In the following, a description will be given of an example of a functional configuration of the imaging apparatus 100 according to the embodiment of the present disclosure using FIG. 2.

As shown in FIG. 2, the imaging apparatus 100 includes a map-data storage section 200, an imaging section 211, an imaging-position-information acquisition section 212, and a map-data acquisition section 220. Also, the imaging apparatus 100 includes a display control section 250, a display section 260, an operation acceptance section 270, a recording control section 280, a content storage section 290, and a content-management-information storage section 300.

The map-data storage section 200 stores map data for displaying a map on the display section 260, and supplies the stored map data to the map-data acquisition section 220. For example, the map data stored in the map-data storage section 200 is data identified by latitude and longitude. The map data is divided into a plurality of areas in units of a certain latitude width and longitude width. In this regard, the map-data storage section 200 corresponds to the recording section 160 illustrated in FIG. 1.

The imaging section 211 shoots a subject to generate a captured image, and outputs the generated captured image to the display control section 250 and the recording control section 280. In this regard, the imaging section 211 corresponds to the camera module 110 illustrated in FIG. 1.

The imaging-position-information acquisition section 212 obtains shooting position information on an imaging position, and outputs the obtained shooting position information to the map-data acquisition section 220 and the recording control section 280. In this regard, the imaging-position-information acquisition section 212 corresponds to the GPS module 120 illustrated in FIG. 1.

The map-data acquisition section 220 obtains map data from the map-data storage section 200 on the basis of the shooting position information output from the imaging-position-information acquisition section 212, and outputs the obtained map data to the display control section 250. In this regard, the map-data acquisition section 220 corresponds to the system control section 140 illustrated in FIG. 1.

The display control section 250 displays on the display section 260 a map corresponding to the captured image output from the imaging section 211, shooting position information output from the imaging-position-information acquisition section 212, and the map data output from the map-data acquisition section 220. Also, the display control section 250 changes a size of the map in accordance with the input operation from the operation acceptance section 270, and displays the map. Detailed descriptions will be given of the examples of these displays later. In this regard, the display control section 250 corresponds to the system control section 140 illustrated in FIG. 1.

The display section 260 is a display section displaying various images under the control of the display control section 250. The display section 260 corresponds to the display section 170 illustrated in FIG. 1.

The operation acceptance section 270 is an operation acceptance section accepting an input operation from the user, and outputs the operation contents in accordance with the accepted input operation to the display control section 250 or the recording control section 280. For example, if the operation acceptance section 270 has accepted an instruction operation to set a monitoring mode, the operation acceptance section 270 outputs the operation contents to the display control section 250. Also, for example, if the operation acceptance section 270 has accepted an instruction operation to record a moving image, the operation acceptance section 270 outputs the operation contents to the display control section 250 and the recording control section 280. Also, for example, if the operation acceptance section 270 has accepted an instruction operation (a so-called shutter operation) to record a still image, the operation acceptance section 270 outputs the operation contents to the recording control section 280. In this regard, the operation acceptance section 270 corresponds to the operation section 150 illustrated in FIG. 1.

The recording control section 280 records the captured image output from the imaging section 211 into the content storage section 290 as a still image content or a moving image content. Also, the recording control section 280 records information output from the imaging-position-information acquisition section 212 into the content-management-information storage section 300 in association with the still image content or the moving image content. For example, if the operation acceptance section 270 has accepted an instruction operation to record a moving image, the recording control section 280 records the captured image output from the imaging section 211 to the content storage section 290 as a moving image content. The recording control section 280 records shooting position information for each frame constituting the moving image content into the content-management-information storage section 300 together with this recording. When recording the moving image, the recording control section 280 may record each information for each frame, or may record each information into the content-management-information storage section 300 for each certain period (for example, for each GOP (Group Of Picture)). Also, for example, if the operation acceptance section 270 has accepted an instruction operation to record a still image, recording control section 280 records the captured image output from the imaging section 211 into the content storage section 290 as a still image content. The recording control section 280 records each information (the shooting position information and the imaging direction information) on the still image content into the content-management-information storage section 300 together with this recording. In this regard, the recording control section 280 corresponds to the system control section 140 illustrated in FIG. 1.

The content storage section 290 records the captured image output from the imaging section 211 as a still image content or a moving image content under the control of the recording control section 280. In this regard, the content storage section 290 corresponds to the recording section 160 illustrated in FIG. 1.

The content-management-information storage section 300 records information output from the imaging-position information acquisition section 212 in association with the captured image under the control of the recording control section 280. In this regard, the content-management-information storage section 300 corresponds to the recording section 160 illustrated in FIG. 1.

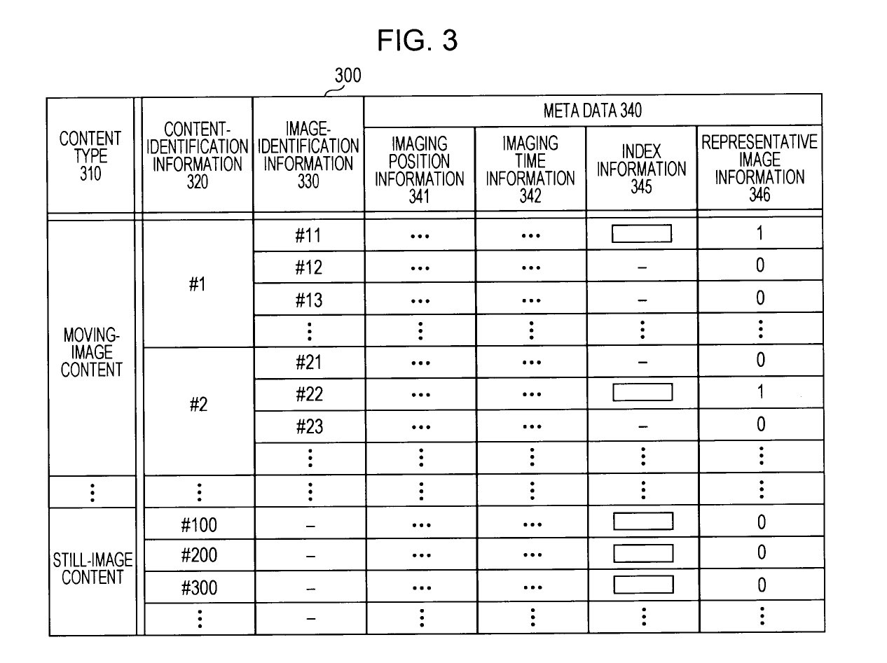

FIG. 3 is a diagram schematically illustrating storage contents of the content-management-information storage section 300 according to an embodiment of the present disclosure. The content-management-information storage section 300 stores meta data 340 classified for each content type (a moving image content and a still image content). Specifically, the content type 310 “moving image content” stores content identification information 320, image identification information 330, and meta data 340 in association with one another. Also, the content type 310 “still image content” stores the content identification information 320 and meta data 340 in association with each other.

The content identification information 320 is identification information for identifying each content, and for example, “#1” and “#2” as content identification information on moving image contents are stored for the information. Also, “#100”, “#200”, and “#300” are stored as content identification information on still image contents for the information.

The image identification information 330 is identification information for identifying each captured image (frame) constituting a moving image content, and for example, “#11”, “#12”, and “#13” are stored in individual captured images, respectively, constituting the moving image content corresponding to the content identification information 320 “#1”. In this regard, identification information is stored in the image identification information 330 for only a captured image having each information in the meta data 340.

The meta data 340 is meta data on each captured image. Shooting position information 341, imaging time information 342, index image 345, and representative image information 346 are stored as meta data. In this regard, in FIG. 3, information stored in the shooting position information 341 and the imaging time information 342 are omitted, and index images stored in the index image 345 are illustrated by rectangles for simplification.

The shooting position information 341 is information including an imaging position (for example, latitude and longitude) at the time of shooting a corresponding captured image. The shooting position information obtained by the imaging-position-information acquisition section 212 is stored in the shooting position information 341.

The imaging time information 342 is information including the time when the corresponding captured image is captured. In this regard, if the content is a moving image, only imaging time of a first frame and a last frame may be stored.

The index image 345 is an index image (representative image) to be used when the corresponding content is selected, and, for example, a thumbnail image of the corresponding captured image is stored there. This thumbnail image is, for example, generated by the recording control section 280.

The representative image information 346 is information for identifying a captured image that has been determined as a representative image among individual captured images constituting the corresponding moving image content. In the example illustrated in FIG. 3, “1” is entered into columns of the captured images that have been determined as a representative image among individual captured images constituting the moving image content, and “0” is entered into columns of the other captured images. Here, in the case of a moving image content, the index images are stored in the index image 345 only for a plurality of the captured images that have been determined as representative images. For a determination method of a representative image, for example, a determination method in which a captured image at the time of receiving a GPS signal first after starting recording operation of a moving image content is determined to be a representative image may be used. For example, a captured image corresponding to the image identification information 330 “#11” is determined as a representative image among the individual captured images constituting the moving image content corresponding to the content identification information 320 “#1”, and an index image of the captured image is stored in the index image 345. In this regard, the above-described determination method of a representative image is an example. A method of determining a representative image by selecting one image from moving image contents using some rule may be used. For example, a determination method in which a beginning image of the moving image content is determined as a representative image may be used.

In this regard, in this example, an example in which meta data is stored in the content-management-information storage section 300 is shown. However, the present disclosure is not limited to such an example. For example, meta data may be stored in each content file.

In the above, a description has been given of the functional configuration of the imaging apparatus 100 according to an embodiment of the present disclosure. Next, a description will be given of operation of the imaging apparatus 100 according to the embodiment of the present disclosure.

1. 2 Operation of Imaging Apparatus

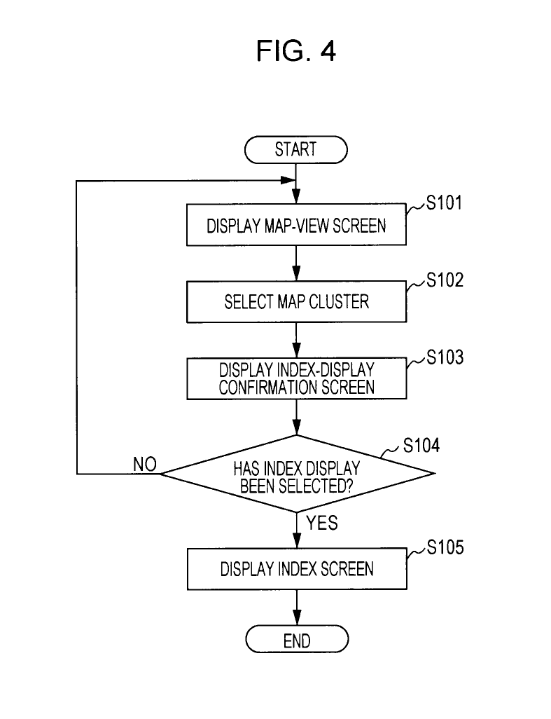

FIG. 4 is a flowchart illustrating operation of the imaging apparatus 100 according to an embodiment of the present disclosure. In the following, a description will be given of operation of the imaging apparatus 100 according to the embodiment of the present disclosure using FIG. 4. The operation of the imaging apparatus 100 described below is performed in a state in which the imaging apparatus 100 has already been started.

In a state in which the imaging apparatus 100 is running, a user of the imaging apparatus 100 performs a predetermined operation using the operation section 150 so that the system control section 140 displays a map-view screen on the display section 170 (step S101). As described above, the map-view screen is a screen on which a map on the display section 170 is displayed, and a thumbnail image of the image captured by the imaging apparatus 100 is displayed in association with a position of the map. Here, the image to be displayed as a thumbnail image is an image whose representative image information 346 is “1” among the image information stored in the content-management-information storage section 300.

In the above-described step S101, in a state in which the system control section 140 displays the map-view screen on the display section 170, the user of the imaging apparatus 100 selects one map cluster among the map clusters displayed on the map-view screen using the operation section 150 (step S102). Then the system control section 140 displays an index-display confirmation screen on the map cluster selected by the user on the display section 170 (step S103). As described above, the index-display confirmation screen is a screen for prompting the user to select whether to display an index screen of the image related to the map cluster or not.

In the above-described step S103, in a state in which the system control section 140 displays the index-display confirmation screen on the display section 170, the imaging apparatus 100 is in a waiting state of determining whether to display the index screen of the content pertaining to the map cluster selected by the user in the above-described step S102. Thus the system control section 140 determines whether the user of the imaging apparatus 100 has selected to display an index screen or not (step S104). In step S104, if determined that the user has selected to display the index screen, the system control section 140 displays the index screen of the map cluster selected by the user on the display section 170 (step S105). On the other hand, in step S104, if determined that the user has not selected to display the index screen index screen, and has selected to return to the original map-view screen, the system control section 140 returns to the above-described step S101, and displays the map-view screen on the display section 170.

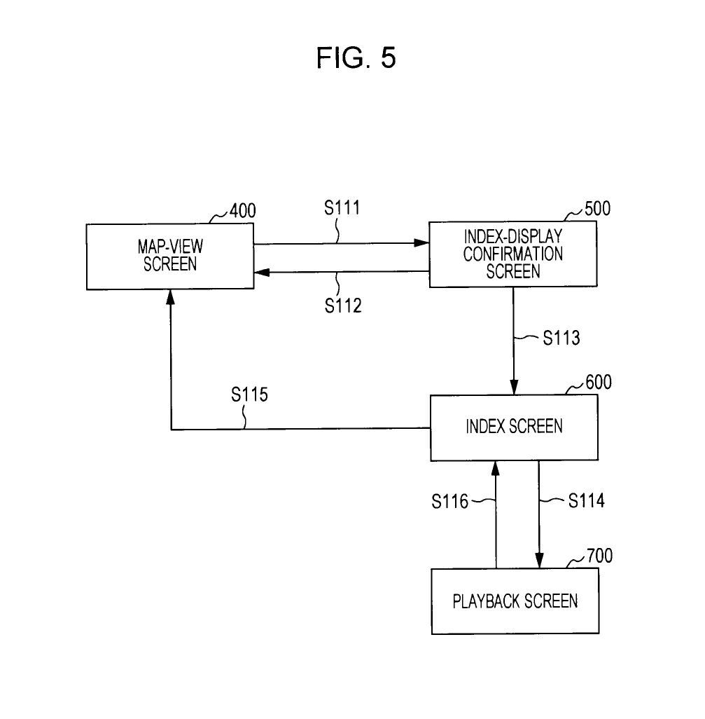

FIG. 5 is an explanatory diagram illustrating an example of transition of screens displayed on the display section 170 of the imaging apparatus 100 according to an embodiment of the present disclosure. In the following, a description will be given of the example of transition of screens displayed on the display section 170 of the imaging apparatus 100 according to the embodiment of the present disclosure using FIG. 5.

In the state in which the imaging apparatus 100 is running, the user of the imaging apparatus 100 performs a predetermined operation using the operation section 150 so that the system control section 140 displays the map-view screen 400 on the display section 170. The display of the map-view screen 400 corresponds to step 5101 in FIG. 4.

In a state in which the system control section 140 displays the map-view screen 400 on the display section 170, the user of the imaging apparatus 100 selects one map cluster from the map clusters displayed on the map-view screen using the operation section 150 (step S111). When a map cluster is selected, the system control section 140 displays an index-display confirmation screen 500 on the map cluster selected by the user on the display section 170. The display of the index-display confirmation screen 500 corresponds to step S103 in FIG. 4.

As described above, in a state in which the system control section 140 displays the index-display confirmation screen 500 on the display section 170, the imaging apparatus 100 is in a waiting state of determining whether to display an index screen of a content pertaining to the map cluster selected by the user in the above-described step S102. If the user selects the display of the index screen (step S113), the system control section 140 displays an index screen 600 of the map cluster selected by the user on the display section 170. The display of the index screen 600 corresponds to step S105 in FIG. 4. On the other hand, if the user does not select the display of the index screen, and selects to return to the original map-view screen (step S114), the system control section 140 displays the map-view screen 400 on the display section 170.

In a state in which the system control section 140 displays the index screen 600 on the display section 170, if the user selects one thumbnail image among the thumbnail images displayed on the index screen 600 (step S114), the system control section 140 displays a playback screen 700 on which a content corresponding to that thumbnail image is displayed on the display section 170. On the other hand, in a state in which the system control section 140 displays the index screen 600 on the display section 170, if the user selects to return to the map-view screen 400 (step S115), the system control section 140 displays the map-view screen 400 on the display section 170.

And in a state in which the system control section 140 displays the playback screen 700 on the display section 170, if the user selects to return to the index screen 600 (step S116), the system control section 140 displays the index screen 600 on the display section 170.

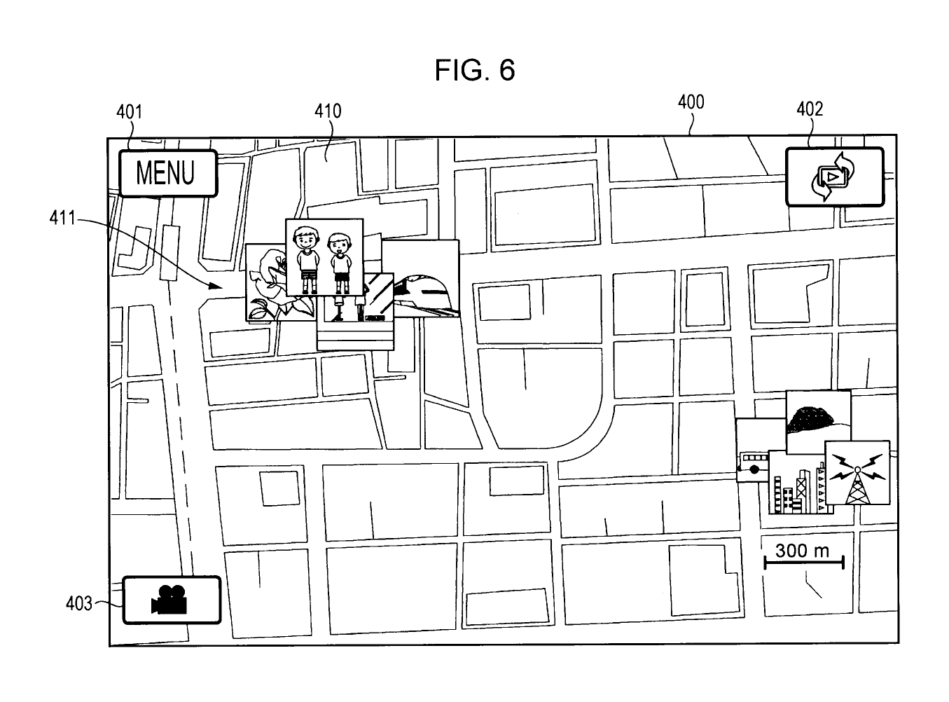

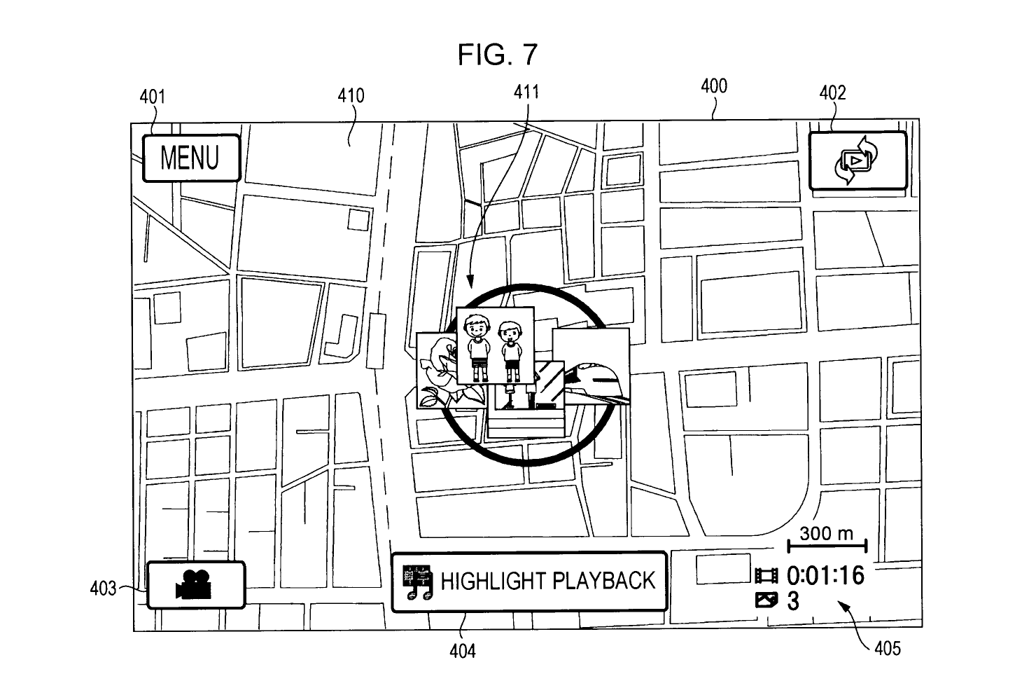

FIG. 6 and FIG. 7 are explanatory diagrams illustrating an example of the map-view screen 400 displayed on the display section 170 of the imaging apparatus 100 according to the embodiment of the present disclosure. In the following, a description will be given of the map-view screen 400 displayed on the display section 170 using FIG. 6 and FIG. 7.

The map-view screen 400 includes a menu button 401 for changing to various menu screens, a view change button 402 for changing between the map-view screen and the other browse screens (view screens), and a shooting-mode change button 403 for performing imaging processing on the imaging apparatus 100.

And the map-view screen 400 includes a map area 410 in which map data is displayed as a full screen, and a map cluster 411 that is displayed in the map area 410 in a superimposed manner. As shown in FIG. 6, the map cluster 411 is displayed in association with a position on the map data displayed on the map area 410, and the thumbnail images of the contents captured in a predetermined range are displayed in a state in which a predetermined number (for example, four) of the images are overlapped in the order from the latest.

The user of the imaging apparatus 100 selects one cluster from the map clusters 411 displayed on the map-view screen 400, so that system control section 140 is allowed to display the index screen 600 on which the contents corresponding to the map cluster are index-displayed on the display section 170. FIG. 7 illustrates a state in which the user of the imaging apparatus 100 has selected one map cluster 411 among the map clusters 411 displayed on the map-view screen 400. When the user selects one map cluster 411, the system control section 140 changes the display of the map data to be displayed on the map area 410 such that the selected map cluster 411 is positioned at the center of the map-view screen 400, and performs a display of a selected state of the map cluster 411 selected by the user. In FIG. 7, the map cluster 411 is enclosed by a circle as a display indicating that the map cluster 411 selected by the user is in a selected state. However, it goes without saying that a display of a selected state is not limited to this example.

As shown in FIG. 7, when it becomes a state in which one map cluster 411 is selected, the system control section 140 displays, on the map-view screen 400, a highlight playback button 404 for performing highlight playback (a mode of extracting and playing back only scenes to be highlights among moving image contents), and a content-information display area 405 in which basic information of the content corresponding to the selected map cluster 411 is displayed. In this embodiment, as basic information of the content corresponding to the selected map cluster 411, total playback time of the moving image is displayed in an upper row, and a number of still images is displayed in a lower row.

And in a sate in which one map cluster 411 is selected as FIG. 7, the user performs selection operation on the map cluster 411 so that the system control section 140 displays the index-display confirmation screen 500 of the map cluster selected by the user on the display section 170.

In this regard, in a state in which one map cluster 411 is selected as in FIG. 7, the user selects (taps) a position other than the map cluster 411 on the map-view screen 400 so that the selection state of the map cluster 411 is released. At that time, the system control section 140 may control the display of the map-view screen 400 such that a user-selected (tapped) position is located at the center.

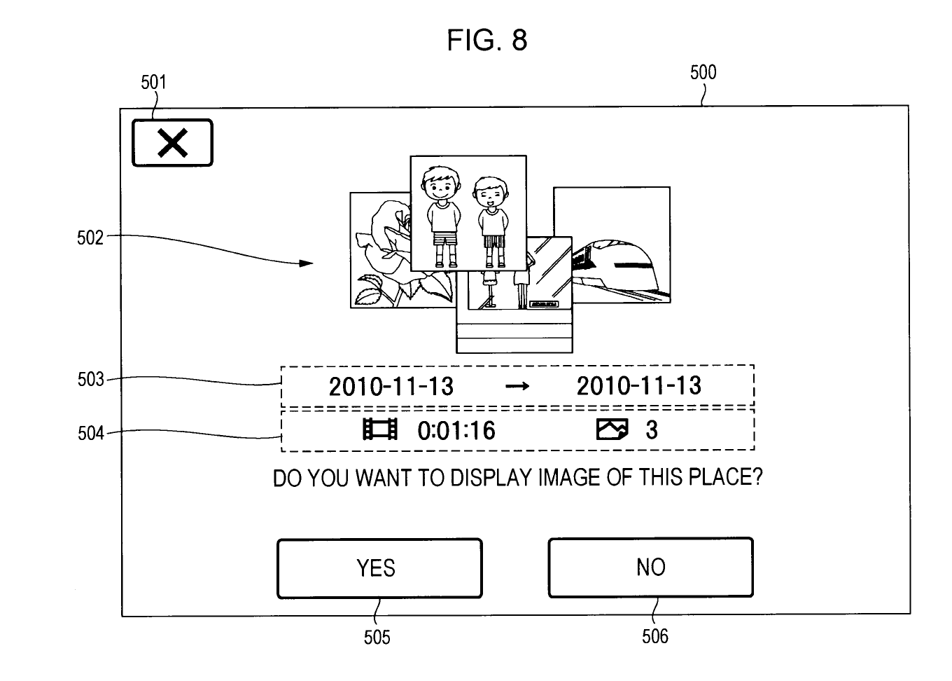

FIG. 8 is an explanatory diagram illustrating a display example of the index-display confirmation screen 500 according to an embodiment of the present disclosure. As shown in FIG. 8, the index-display confirmation screen 500 according to the embodiment of the present disclosure includes a return button 501 for returning to the map-view screen 400, a map-cluster display area 502 displaying a map cluster selected by the user, an additional-information display area 503 displaying information, such as shooting date on which the content pertaining to the map cluster selected by the user, etc., a content-information display area 504 displaying basic information on the content corresponding to the selected map cluster 411, and selection buttons 505 and 506 prompting the user to select whether to change to an index screen 600.

If the user presses the return button 501 or the selection button 506 displayed on the index-display confirmation screen 500, the system control section 140 displays the map-view screen 400 on the display section 170. On the other hand, if the user presses the selection button 505 displayed on the index-display confirmation screen 500, the system control section 140 displays the index screen 600 displaying an index of the contents pertaining to the map cluster selected by the user on the display section 170.

And the index-display confirmation screen 500 according to the embodiment of the present disclosure has an additional-information display area 503 where information that is not displayed on the map-view screen 400 is displayed in a state in which the user of the imaging apparatus 100 has selected one map cluster 411 out of the map clusters 411 displayed on the map-view screen 400 (FIG. 7).

In this embodiment, as shown in FIG. 8, information on shooting date of the content pertaining to the map cluster selected by the user is displayed in the additional-information display area 503. However, information to be displayed in the additional-information display area 503 is not limited to such an example, as a matter of course. For example, the system control section 140 may display information on the latitude and the longitude of the place where the content pertaining to the map cluster selected by the user is captured in the additional-information display area 503.

In addition, if the map-data storage section 200 has information on a place name and a spot corresponding to the latitude and the longitude, the system control section 140 may display information on the place name and the spot where the content pertaining to the map cluster selected by the user in the additional-information display area 503. By displaying information on the place name and the spot where the content is captured in the additional-information display area 503, it is possible for the user to grasp at which place the content pertaining to the map cluster has been captured, and to get assistance for playback-displaying the content.

In this regard, broken lines with reference numerals 503 and 504 added in FIG. 8 are illustrated for the sake of explanation, and are not actually displayed on the index-display confirmation screen 500.

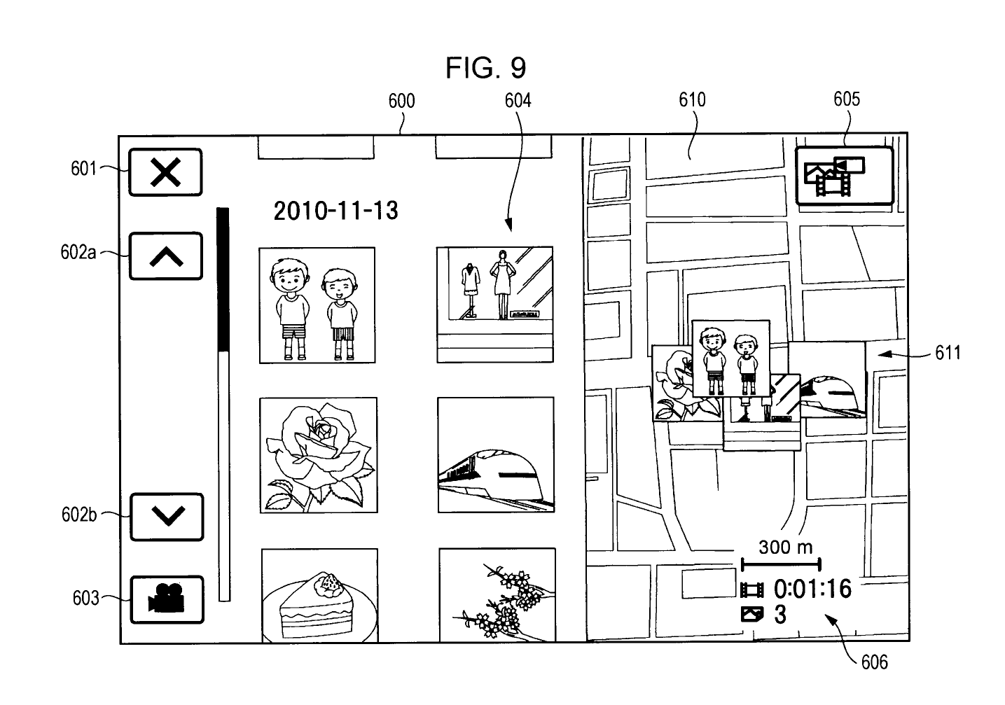

FIG. 9 is an explanatory diagram illustrating a display example of an index screen 600 according to an embodiment of the present disclosure. As shown in FIG. 9, the following items are displayed on the index screen 600 according to an embodiment of the present disclosure: a return button 601 for returning to the map-view screen, scroll buttons 602a and 602b for scrolling a display of the thumbnail image 604, a shooting-mode change button 603 for executing imaging processing on the imaging apparatus 100, a thumbnail-image display area 604 for displaying thumbnail images, a content change button 605 for changing a type of content to be displayed in the thumbnail-image display area 604, a content-information display area 606 for displaying basic information of the content corresponding to the selected map cluster 611, a map area 610 for displaying map data on the right-half screen, and a map cluster 611 selected by the user in the map-view screen 400.

When the user of the imaging apparatus 100 performs selection operation of a thumbnail image displayed on the thumbnail-image display area 604, the imaging apparatus 100 performs display/playback processing of the content corresponding to the selected thumbnail image on the display section 170. And when the user of the imaging apparatus 100 performs selection operation of the return button 601, the imaging apparatus 100 performs processing to return a display screen on the display section 170 to the map-view screen 400.

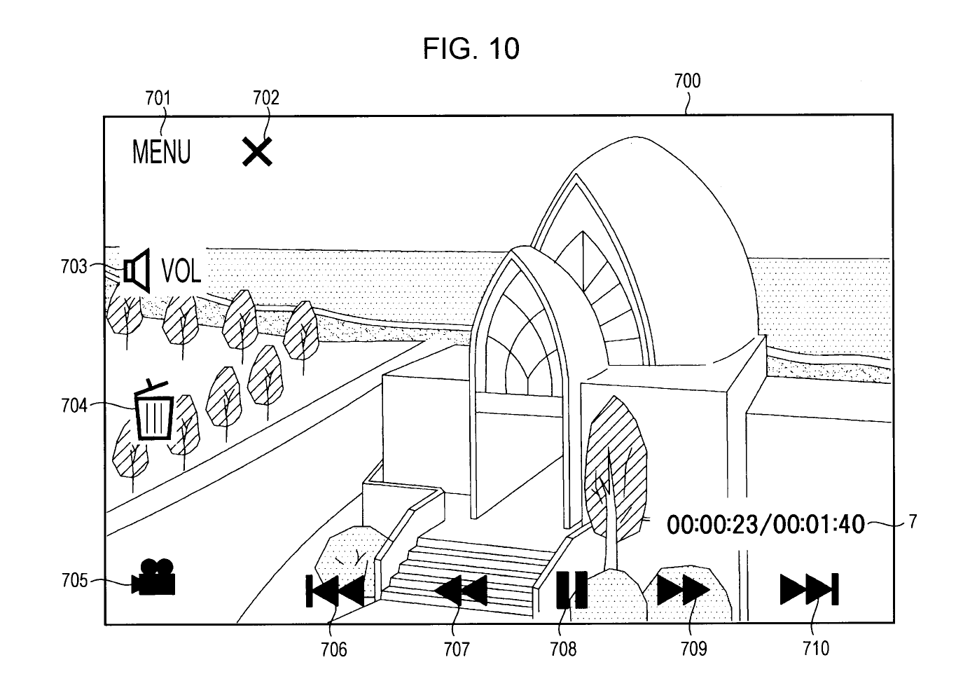

FIG. 10 is an explanatory diagram illustrating a display example of a playback screen 700 according to an embodiment of the present disclosure. As shown in FIG. 10, the following items are displayed on the playback screen 700 according to the embodiment of the present disclosure: a menu button 701 for returning to a predetermined menu screen, a return button 702 for stopping playback and returning to the index screen 600, a sound volume button 703 for adjusting a sound volume of a content being played back, a deletion button 704 for deleting a content being played back, a shooting-mode change button 705 for executing imaging processing on the imaging apparatus 100, a skip button 706 for returning to a previous content, a reverse button 707 for reversing a content, a playback/pause button 708 for playing back or pausing a content, a forward button 709 for forwarding a content, a skip button 710 for advancing to a next content, and a playback-time display area 711 for displaying information on playback time and total playback time of a content.

By displaying such a playback screen 700 on the display section 170, the imaging apparatus 100 allows the user to perform playback operation of a content.

In the above, a description has been given of the screens displayed on the display section 170 of the imaging apparatus 100 according to an embodiment of the present disclosure. Of course, the configurations of the screens displayed on the display section 170 of the imaging apparatus 100 according to the present disclosure are not limited to those described here.

2. Overview

As described above, in the imaging apparatus 100 according to an embodiment of the present disclosure, by a predetermined operation of the user, on the display section 170, a map-view screen 400 is displayed on which thumbnail images of the content (still images and moving images) captured by the imaging apparatus 100 are mapped and displayed together with a map in association with positions on the map.

In a state in which the map-view screen 400 is displayed on the display section 170, if the user selects one map cluster from the map clusters displayed on the map-view screen 400, basic information (playback time of a moving image and a number of still images) of the content pertaining to the map cluster selected by the user is displayed on the map-view screen 400.

And when the display on the display section 170 is changed from a state in which one map cluster is selected on the map-view screen 400 to the index-display confirmation screen 500 prompting the user to select a display of the index screen of the map cluster, the index-display confirmation screen 500 displays an additional-information display area 503 for displaying information that has not been displayed on the map-view screen 400 in a state (FIG. 7) in which one map cluster 411 is selected from the map clusters 411 displayed on the map-view screen 400. Thereby, the user is allowed to confirm when the content pertaining to the selected map cluster has been captured, and at which place the content has been captured, etc.

In this regard, a series of processing described in the above-described embodiment may be executed by dedicated hardware, or may be executed by software (application). When the series of processing is executed by software, it is possible to achieve the above-described series of processing by a general-purpose computer or a dedicated computer performing a computer program.

Also, icon designs and information-disposition positions in the drawings referenced in the above-described embodiment are not limited to those illustrated in the individual figures as a matter of course. It is possible to determine any design and to dispose icons and information at any position without departing from the scope of the present disclosure.

In the above, a detailed description has been given of a preferable embodiment of the present disclosure with reference to the accompanying drawings. However, the present disclosure is not limited to this example. It is obvious to a person who has a common knowledge in the technical field to which the present disclosure pertains that various changes or modifications may be made within the spirit and scope of the appended claims. Such changes and modifications are of course construed within the spirit and scope of the present disclosure.

For example, in the description of the above embodiment, shooting date and time of a content pertaining to a map cluster is displayed on the index-display confirmation screen as information not displayed on the map-view screen. However, the present disclosure is not limited to such an example. For example, the system control section 140 may be provided with a face detection function. And if a face is included in a content pertaining to a map cluster, the system control section 140 may extract a face portion from the content, and may display the face on the index-display confirmation screen. Thereby, it becomes possible for a user of the imaging apparatus 100 to check who is taken in a content pertaining to a map cluster selected on a map-view screen before displaying an index.

Also, for example, if the system control section 140 is provided with a face detection function, the system control section 140 may identify whether a detected face is male or female, or whether a detected face is an adult or a child. If a face is included in a content pertaining to a map cluster, the system control section 140 may display who and how many persons are taken on the index-display confirmation screen. Thereby, it becomes possible for a user of the imaging apparatus 100 to check what kind of persons and how many persons are taken in a content pertaining to a map cluster selected on a map-view screen before displaying an index.

The present disclosure contains subject matter related to that disclosed in Japanese Priority Patent Application JP 2011-000346 filed in the Japan Patent Office on Jan. 5, 2011, the entire contents of which are hereby incorporated by reference.

What is claimed is:

1. An information processing apparatus comprising:
a display section displaying an image; and
a control section displaying, on the display section, a map-view screen including a display of a map cluster including thumbnail images of one or a plurality of images recorded in a recording section, with position information attached, on a map, and when one map cluster is selected from the map clusters, an index-display confirmation screen including a display of information not displayed on the map-view screen of the map cluster and not displaying the map having been displayed on the map-view screen, and prompting to select whether to display an index of images included in the map cluster.

2. The information processing apparatus according to claim 1,
wherein when the index-display confirmation screen is displayed on the display section, if a user selects a display of an index of captured images on the display section, the control section changes the display on the display section from the index-display confirmation screen to an index screen displaying the index of the captured images pertaining to the map cluster selected by the user.

3. The information processing apparatus according to claim 2,
wherein in order for the control section to change to the map-view screen after having changed the display on the display section from the index-display confirmation screen to the index screen, the control section directly changes the screen without going through the index-display confirmation screen.

4. The information processing apparatus according to claim 1,
wherein when the control section displays the index-display confirmation screen on the display section, the control section displays information on a shooting date of a captured image pertaining to the map cluster selected as information not having been displayed on the map-view screen.

5. The information processing apparatus according to claim 1,
wherein when the control section displays the index-display confirmation screen on the display section, the control section displays information on latitude and longitude of a shooting location of a captured image pertaining to the map cluster selected as information not having been displayed on the map-view screen.

6. The information processing apparatus according to claim 1,
wherein when the control section displays the index-display confirmation screen on the display section, the control section displays a name of a shooting location of a captured image pertaining to the map cluster selected as information not having been displayed on the map-view screen.

7. The information processing apparatus according to claim 1,
wherein when the control section displays the index-display confirmation screen on the display section, the control section displays a face image included in a captured image pertaining to the map cluster selected as information not having been displayed on the map-view screen.

8. A method of displaying information, comprising:
controlling a display of a map-view screen including a display of a map cluster including thumbnail images of one or a plurality of images recorded in a recording section with position information attached on a map on a display section; and
when one map cluster is selected from the map clusters, controlling a display of an index-display confirmation screen including a display of information not displayed on the map-view screen of the map cluster and not displaying the map having been displayed on the map-view screen, and prompting to select whether to display an index of images included in the map cluster.

9. A computer program for causing a computer to perform processing comprising:
controlling a display of a map-view screen including a display of a map cluster including thumbnail images of one or a plurality of images recorded in a recording section with position information attached on a map on a display section; and
when one map cluster is selected from the map clusters, controlling a display of an index-display confirmation screen including a display of information not displayed on the map-view screen of the map cluster and not displaying the map having been displayed on the map-view screen, and prompting to select whether to display an index of images included in the map cluster.
